(19) United States
(12) Patent Application Publication
(10) Pub. No.: US 2024/0070280 A1
(43) Pub. Date: Feb. 29, 2024

(54) LOCKED STATES

(71) Applicant: Hewlett-Packard Development Company, L.P., Spring, TX (US)

(72) Inventors: Jeffrey Kevin Jeansonne, Houston, TX (US); Richard Alden Bramley, JR., Mansfield, MA (US); Valiuddin Ali, Spring, TX (US)

(21) Appl. No.: 17/899,176

(22) Filed: Aug. 30, 2022

(51) Int. Cl. G06F 21/57; G06F 21/33; G06F 21/36

(52) U.S. Cl. CPC G06F 21/572; G06F 21/33; G06F 21/36

(57) ABSTRACT

Examples of electronic devices are described herein. In some examples, an electronic device includes an operating system. In some examples, the electronic device includes a processor. In some examples, the processor is to generate a first code. In some examples, the processor is to encrypt the first code based on a public key to produce a second code. In some examples, the processor is to enter a locked state, where a booting of the operating system is blocked in the locked state. In some examples, the locked state is unlockable with the first code. In some examples, the electronic device includes a communication device to output the second code. In some examples, the communication device is to receive an authentication message in response to the second code. In some examples, the processor is to enter an unlocked state based on the authentication message.

### BACKGROUND

Computing devices execute programs to perform functions. For instance, a computing device may include a program in memory that may be executed by a processor. Examples of computing devices include desktop computers, laptop computers, tablet devices, and smartphones.

### BRIEF DESCRIPTION OF THE DRAWINGS

FIG. 1 is a diagram of a timeline illustrating examples of some of the techniques described herein for locking electronic devices;

FIG. 2 is a block diagram illustrating an example of an electronic device that may be used to control a locked state;

FIG. 3 is a block diagram illustrating an example of a computer-readable medium for controlling locked states;

FIG. 4 is a thread diagram illustrating an example of locked state control in accordance with some examples of the techniques described herein; and

FIG. 5 is a thread diagram illustrating an example of locked state control in accordance with some examples of the techniques described herein.

### DETAILED DESCRIPTION

Some electronic devices (e.g., computers, laptops, smartphones, tablet devices, Internet of Things (IoT) devices, etc.) may be set up during manufacturing and shipped to a customer. For instance, when a computing device is manufactured, an operating system, application(s), setting(s), or a combination thereof may be installed, loaded, set, or a combination thereof.

In some approaches, an electronic device may be placed in a locked state after setup. A locked state is a state where booting of an operating system is blocked. For instance, once an electronic device is built and set up, the electronic device may be placed in a locked state for shipping to a user. The locked state may block a third party from booting the electronic device into the operating system.

In some examples, the locked state may present a challenge to factory audit procedures, factory rework procedures, or a combination thereof. For instance, the electronic device is blocked from booting for audit or rework once in the locked state. In some approaches, a manual procedure may be used to unlock the electronic device, which may be time consuming and expensive.

Some examples of the techniques described herein may provide approaches to unlock electronic devices in a locked state. For instance, some examples may enable unlocking that is secure, network based, automated, or a combination thereof. In some examples, unlocking may be employed from the locked state without manual operations or increased delays in a factory to enable electronic devices to be audited, reworked, or a combination thereof.

Throughout the drawings, similar reference numbers may designate similar or identical elements. When an element is referred to without a reference number, this may refer to the element generally, without limitation to any particular drawing or figure. In some examples, the drawings are not to scale, and the size of some parts may be exaggerated to more clearly illustrate the example shown. Moreover, the drawings provide examples in accordance with the description. The description is not limited to the examples provided in the drawings.

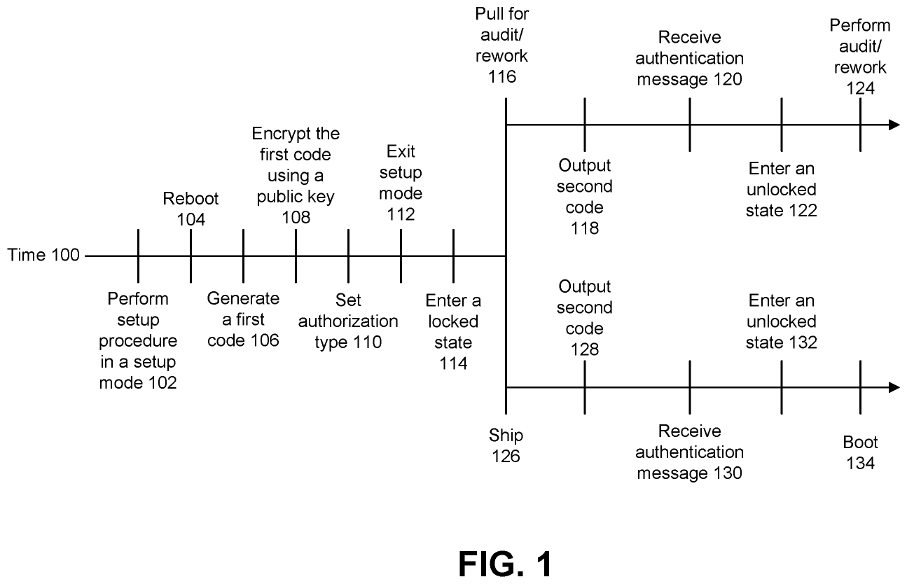

FIG. 1 is a diagram of a timeline illustrating examples of some of the techniques described herein for locking electronic devices. FIG. 1 illustrates operations over time 100. For instance, FIG. 1 illustrates sequences of operations that may be performed in accordance with some examples of the techniques herein. In some examples, a different order of operations may be performed. The sequences of operations illustrated in FIG. 1 may be performed in varying periods of time. In some examples, an operation(s) described in FIG. 1 may be omitted or re-ordered.

In the example of FIG. 1, a setup procedure is performed while an electronic device is in a setup mode at step 102. A setup mode is a mode that allows initial setup of an electronic device during manufacturing. A setup of an electronic device is a state of data on the electronic device. For example, a setup may include a state of a hard drive image, operating system, installed applications, settings, policies, etc., or a combination thereof on an electronic device. “Setting up” an electronic device may include applying an operation or operations (e.g., installing programs, storing data, updating policies, updating settings, etc.) to achieve a setup. In some examples, an operating system (OS) may be loaded to the electronic device during setup. The OS may be booted to install an application(s), to set a setting(s), to set a policy(ies), etc., or a combination thereof.

The electronic device may reboot at step 104. For instance, the electronic device may be rebooted to complete installation of an application(s).

The electronic device generates a first code at step 106. For instance, the electronic device may generate a random sequence of values, numbers, characters, or a combination thereof. In some examples, the first code may be a personal identification number (PIN). The first code may be utilized to unlock an electronic device in a locked state. For instance, the electronic device may enter an unlocked state when receiving a code that matches the first code.

The electronic device encrypts the first code using a public key at step 108. As used herein, a public key is a cryptographic value (e.g., number, string of characters, etc.) that may be available to an entity(ies) (e.g., non-issuing entity(ies)). In some examples, a public key and a private key may be generated using an asymmetric cryptography technique (e.g., public-key cryptography). A private key is a cryptographic value (e.g., number, string of characters, etc.) to be kept secret or confidential to an entity (e.g., issuing entity). In some examples, an entity (e.g., customer company, entity that ordered manufacture of the electronic device(s)) may generate a public key and private key pair. The entity may send the public key to the electronic device manufacturer, while keeping the corresponding private key confidential. The manufacturer (e.g., manufacturer server, manufacturer electronic device, manufacturer computing device, manufacturer electronic storage device, etc.) may load the public key to the electronic device. The electronic device may encrypt the first code based on a public key to produce a second code. The second code may be an encrypted value. For instance, the second code may be decrypted to produce an unlock code matching the first code.

The electronic device sets an authorization type at step 110. An authorization type is a setting indicating how the electronic device locking mechanism will function. For instance, an “always” authorization type indicates an electronic device may always be locked before booting, an “initial lock” authorization type indicates that an electronic device may be locked before booting until an initial or one-time unlock is performed (after which the electronic device may boot without being in a locked state, for instance), an “initial unlock” authorization type indicates that an electronic device may be unlocked for a first boot (after which the electronic device may be locked before each boot, for instance), and a “never” authorization type indicates that an electronic device may never be locked before booting. In some examples, the aforementioned authorization types may be utilized, more authorization types may be utilized, fewer authorization types may be utilized, a default authorization type may be utilized, or a combination thereof. In some examples, the authorization type may be set based on input from a manufacturer (e.g., input from a factory server, user input, input based on a customer order, or a combination thereof).

The electronic device exits the setup mode at step 112. For instance, the electronic device exits the setup mode, where exiting the setup mode may block another entity(ies) (besides the manufacturer, for instance) from using the setup mode to modify the electronic device.

The electronic device enters a locked state at step 114. For example, the electronic device may log out of an OS, may shut down, or a combination thereof. Once the electronic device enters the locked state, booting the OS may be blocked until a valid authentication message is received. For instance, in a case that the authorization type is set to lock the electronic device, a basic input/output system (BIOS) may block booting the OS upon electronic device activation until a valid authentication message is received. An authentication message is information to unlock the electronic device. For instance, an authentication message may include an unlock code (e.g., PIN), a certificate, or a combination thereof. A valid authentication message is an authentication message capable of successful verification. In a case that an authentication message includes an invalid unlock code or an invalid certificate, the electronic device may remain in the locked state.

During manufacturing, some electronic devices may be shipped to customers, while other electronic devices may be selected for audit, rework, or a combination thereof. For instance, an audit may include testing of the electronic device to verify target operation. Rework may include fixing an error or issue of the electronic device (e.g., erroneous setup). The branches of the timeline of FIG. 1 illustrate different potential scenarios for an electronic device.

In some scenarios, an electronic device is pulled for audit or rework at step 116. For instance, an electronic device may be held (from shipping, for instance) for audit, rework, or a combination thereof. In some examples, an electronic device may be pulled for rework in a case that factory log off was unsuccessful, if an error was detected during setup, or a combination thereof. In some examples, an electronic device may be pulled for audit for quality assurance purposes. For instance, a proportion (e.g., 3%) of electronic device may be randomly pulled for audit.

An electronic device that is pulled for audit or rework may output a second code at step 118. For instance, when the electronic device is activated (e.g., when a BIOS is activated), the electronic device may output the second code. In some examples, the electronic device may utilize a network link to output the second code. For instance, the electronic device may send the second code to an internal manufacturing factory server (e.g., a server on an intranet of the manufacturing factory). In some examples, the electronic device may send an identifier (e.g., a universally unique identifier (UUID)) to the internal manufacturing factory server with the second code.

The electronic device receives an authentication message at step 120. For instance, the internal manufacturing factory server may generate a certificate in response to receiving the second code, the identifier, or a combination thereof from the electronic device. In some examples, the certificate may include a manufacturer signature. A signature is a value (e.g., string of characters, number, etc.) produced using a private key. For instance, a trusted entity may utilize a signing technique (e.g., signing program) to produce a signature based on content (e.g., certificate content, a hash, etc.) and a private key. For example, content may be encrypted using the private key to produce the signature. In some examples, the internal manufacturing factory server may produce a signature using content of a certificate and a private key. The signature may be appended to the certificate. The internal manufacturing factory server may send the certificate in the authentication message to the electronic device.

The electronic device may enter an unlocked state at step 122. For instance, the electronic device may verify the authentication message (e.g., certificate) and may enter the unlocked state in response to a successful verification. In some examples, a signature may be verified by decrypting the signature using a public key. In some examples, a signature may be decrypted using a public key of the manufacturer, and the decrypted content may be compared with the original content to verify the authenticity of the content. For instance, the signature of a certificate may be decrypted using the public key of the certificate, and the decrypted content (e.g., a decrypted hash) may be compared with the original content (e.g., a hash of the original content) of the certificate. For instance, the electronic device may compare the certificate of the authentication message with another certificate (e.g., signing certificate, intermediate certificate, root certificate, etc.) stored on the electronic device (e.g., BIOS). In a case that the certificate verification is successful, the electronic device may enter the unlocked state.

Audit or rework may be performed at step 124. For instance, the electronic device may boot an OS and the manufacturer may perform the audit, rework, or a combination thereof. In some examples, setup of the electronic device, locking of the electronic device, or a combination thereof may be performed again during or following the audit or rework. In some examples, the electronic device that has undergone audit or rework may be packaged and shipped.

In some scenarios, an electronic device is shipped at step 126. For instance, an electronic device may be packaged and shipped to an ordering entity (e.g., customer).

An electronic device that has been shipped may output a second code at step 128. For instance, when the electronic device is activated (e.g., when a BIOS is activated) by a user, the electronic device may output the second code.

In some examples, the electronic device may generate a quick response (QR) code based on the second code. For instance, the QR code may indicate the second code. The electronic device may output the second code by sending the QR code to a display panel (e.g., to an integrated display panel or to a display device coupled to the electronic device). In some examples, the QR code may be scanned by a device (e.g., mobile device, camera, etc.) and decoded to produce the second code. In some examples, the device may decrypt the second code using a private key to produce an unlock code to unlock the electronic device. In some examples, the second code may be relayed to another device (e.g., server) to decrypt the second code using a private key to produce an unlock code that may be returned. The decrypted unlock code may be included in an authentication message. For instance, a user may input the unlock code to the electronic device.

In some examples, the electronic device may utilize a network link to output the second code. For instance, the electronic device may send the second code to a server (e.g., a server on an intranet of the customer or ordering entity). In some examples, the electronic device may send an identifier (e.g., a UUID) to the server with the second code. In some examples, the server may decrypt the second code based on a private key to produce an unlock code. For instance, the server may retrieve a private key corresponding to a public key that was sent to the manufacturer. The private key may be utilized to decrypt the second code to produce an unlock code to unlock the electronic device. The unlock code may be included in an authentication message to the electronic device.

The electronic device receives an authentication message at step 130. In some examples, the electronic device may receive the authentication message from an input device (e.g., keyboard, touchscreen, microphone, etc.). For example, a user may input the authentication message (e.g., unlock code, PIN) to the electronic device using an input device. In some examples, the server (e.g., customer server, ordering entity server, etc.) may send the authentication message (e.g., unlock code, PIN) to the electronic device over a network.

In some examples, the electronic device may receive the authentication message from a server (e.g., customer server, ordering entity server, etc.). For example, the electronic device may receive the authentication message (e.g., unlock code, PIN) over a network link.

The electronic device may enter an unlocked state at step 132. For instance, the electronic device may verify the authentication message (e.g., unlock code, PIN) and may enter the unlocked state in response to a successful verification. For instance, the electronic device may compare the unlock code to the first code. If the unlock code matches the first code, the electronic device may enter the unlocked state. For instance, a BIOS may enter the unlocked state in a case that the authentication message includes an unlock code that matches the first code.

The electronic device may boot at step 134. For instance, a BIOS of the electronic device may boot an OS of the electronic device.

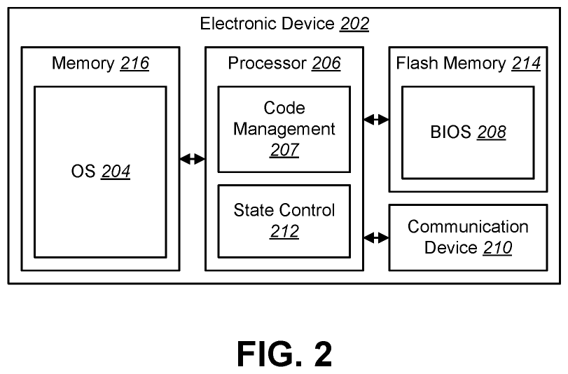

FIG. 2 is a block diagram illustrating an example of an electronic device 202 that may be used to control a locked state. An electronic device is a device that includes electronic circuitry (e.g., integrated circuitry). A computing device is an electronic device that includes a processor, logic circuitry, or a combination thereof. Examples of computing devices may include desktop computers, laptop computers, tablet devices, smartphones, televisions, game consoles, smart speakers, voice assistants, Internet of Things (IoT) devices, etc. A computing device may utilize processor(s) or logic circuitry to perform an operation or operations. In some examples, computing devices may execute instructions stored in memory to perform the operation(s). Instructions may be code or programming that specifies functionality or an operation of a processor or logic circuitry.

In FIG. 2, the electronic device 202 may include a memory 216, processor 206, a flash memory 214, and a communication device 210. In some examples, the processor 206 may include a central processing unit (CPU). The CPU may be a processor to perform an operation on the electronic device 202. Examples of the processor 206 may include a general-purpose processor, a microprocessor, etc. In some examples, the processor 206 may be an application processor. In some examples, the processor 206 may execute instructions (e.g., a program(s), application(s), OS 204, etc.) stored in the memory 216, may execute instructions (e.g., a program(s), application(s), BIOS 208, etc.) stored in the flash memory 214.

Data (e.g., information, instructions, or a combination thereof) may be stored in memory (e.g., volatile memory, non-volatile memory, or a combination thereof). Examples of memory may include Random Access Memory (RAM), Read-Only Memory (ROM), Erasable Programmable ROM (EPROM), Electrically Erasable Programmable ROM (EEPROM), flash memory, etc.), a storage device, an optical disc, the like, or a combination thereof. For instance, data may be stored in volatile or non-volatile memory, such as Dynamic Random Access Memory (DRAM), embedded MultiMediaCard (eMMC), magnetoresistive random-access memory (MRAM), phase change RAM (PCRAM), Synchronous Dynamic Random Access Memory (SDRAM), Double Data Rate (DDR) RAM, memristor, flash memory, the like, or a combination thereof. In some examples, memory may refer to a non-transitory tangible machine-readable storage medium, where the term “non-transitory” does not encompass transitory propagating signals.

In some examples, the electronic device 202 may include a memory 216. For instance, instructions for an OS 204 may be stored in an electronic, magnetic, optical, other physical storage device, or a combination thereof. In some examples, the memory 216 may include multiple devices (e.g., a RAM card and a solid state drive (SSD)). In some examples, the OS 204 may include data, instructions for execution by the processor 206, or a combination thereof.

As used herein, an OS (e.g., OS 204) refers to hardware or hardware and instructions to control or operate a device (e.g., the electronic device 202, etc.). For instance, an OS may operate after a boot procedure performed by a BIOS (e.g., BIOS 208). Instructions included in an OS may be code, microcode, or other programming that defines or controls functionality or operation of an OS. In some examples, the OS 204 may be realized using instructions executable by the processor 206.

In some examples, the memory 216 may be separate from a flash memory 214 to store BIOS instructions. In some examples, the memory 216 to store OS instructions may have a larger storage capacity than the flash memory 214 to store BIOS instructions. In some examples, the memory 216 may be coupled to a motherboard (not shown in FIG. 2) of the electronic device 202 (via serial advanced technology attachment (SATA), parallel advanced technology attachment (PATA), integrated drive electronics (IDE), non-volatile memory express (NVMe), RAM slot(s), or a combination thereof, for instance).

As used herein, a BIOS refers to hardware or hardware and instructions to initialize, control, or operate a device (e.g., the electronic device 202, etc.) prior to execution of an OS of the device, during execution of the OS of the device, or a combination thereof. Instructions included within a BIOS may be software, firmware, microcode, or other programming that defines or controls functionality or operation of a BIOS. In one example, a BIOS may be implemented using instructions, such as platform firmware of a device, executable by a processor. In some examples, the processor 206 may execute BIOS instructions to perform an operation or operations described herein. In some examples, BIOS instructions may be stored in a memory (e.g., flash memory 214, ROM, etc.) and executed by the processor 206 to perform a BIOS operation. A BIOS may operate or execute prior to the execution (e.g., booting) of an OS of a device, during the execution of the OS, or a combination thereof. The BIOS 208 may initialize, control, or operate components such as hardware components of the electronic device 202 and may load or boot the OS 204 of the electronic device 202.

In some examples, the BIOS 208 may provide or establish an interface between hardware devices or platform firmware of the electronic device 202 and the OS 204 of the electronic device 202, via which the OS 204 of the electronic device 202 may control or operate hardware devices or platform firmware of the electronic device 202. In some examples, a BIOS may implement the Unified Extensible Firmware Interface (UEFI) specification or another specification or standard for initializing, controlling, or operating a device.

In some examples, the electronic device 202 may be linked to another electronic device or devices using a wired link, a wireless link, or a combination thereof. For example, the electronic device 202 may include a communication device 210 for linking to another device(s) (e.g., switch, router, server, computer, etc.). In some examples, the communication device 210 may be utilized to link a peripheral device(s) (e.g., input device(s), keyboard, mouse, touchscreen, microphone, output device(s), monitor, speaker, etc.) to the electronic device 202 to receive input, to produce output, or a combination thereof. Examples of wired communication devices may include an Ethernet interface, Universal Serial Bus (USB) interface, fiber interface, Lightning® interface, etc. In some examples, a computing device may include a wireless communication device to send wireless (e.g., radio frequency (RF)) signals, receive wireless signals, or a combination thereof. Examples of wireless communication devices may include an Institute of Electrical and Electronics Engineers (IEEE) 802.11 (Wi-Fi) interface, Bluetooth® interface, cellular (e.g., 3G, Long-Term Evolution (LTE), 4G, 5G, etc.) interface, etc.

A link between electronic devices may be a direct link (e.g., without an intervening device) or an indirect link (e.g., with an intervening device or devices). For instance, a link may be established between electronic devices over a network using a modem(s), router(s), switch(es), hub(s), repeater(s), etc., or a combination thereof.

In some examples, the processor 206 may perform code management 207. For instance, the processor 206 may execute instructions stored in the memory 216 (e.g., OS 204), in the flash memory 214 (e.g., BIOS 208), or in a combination thereof to manage a code(s) (e.g., generate a code(s), encrypt a code(s), compare codes, etc., or a combination thereof).

In some examples, the processor 206 generates a first code. For instance, the processor 206 may generate a first code as described in FIG. 1. In some examples, the processor 206 may generate the first code using a random number generator. For instance, a locked state of the electronic device 202 may be unlockable with the first code. In some examples, the first code may represent a PIN.

In some examples, the processor 206 may encrypt the first code based on a public key to produce a second code. For instance, the electronic device 202 (e.g., communication device 210) may receive the public key from a user, manufacturer (e.g., manufacturer server), entity (e.g., ordering entity, customer company, etc.), or a combination thereof. In some examples, the first code may be encrypted by executing public key cryptography instructions to produce the second code (e.g., encrypted code).

In some examples, the processor 206 may perform state control 212 (e.g., enter a locked state, enter an unlocked state, etc.). For example, the processor 206 (e.g., BIOS 208) may enter a locked state, where a booting of the OS 204 is blocked in the locked state. For instance, the electronic device 202 may enter the locked state as described in FIG. 1. In some examples, the locked state may be entered by setting an authorization type, setting a variable in memory, logging off, shutting down, or a combination thereof. While in the locked state, the BIOS 208 may block booting of the OS 204 (e.g., block, defer, restrict, etc., looking up a storage device that includes the OS 204).

In some examples, the BIOS 208 (e.g., processor 206) may determine whether a condition is satisfied. The communication device 210 may send the second code in a case that the condition is satisfied. For instance, the BIOS 208 may produce, in response to an activation, a determination that a condition is satisfied. When the electronic device 202 is activated (e.g., powered on), for example, the BIOS 208 (e.g., processor 206) may determine whether the electronic device 202 is able to communicate with another device. In some examples, the condition(s) may include whether the electronic device 202 is in a locked state, whether a network adapter is present, whether a network link is present, whether network unlocking is enabled, or a combination thereof. For instance, the condition(s) may be satisfied in a case that the electronic device 202 is in the locked state, a network adapter is present, a network link is present, network unlocking is enabled, or a combination thereof.

In some examples, the BIOS 208 may read a variable (e.g., a variable stored in the memory 216 or in the flash memory 214) indicating whether the electronic device 202 is in a locked state. For instance, the BIOS 208 may determine that a variable indicates that the electronic device 202 is in a locked state. In some examples, the BIOS 208 may read a network unlock variable (e.g., a network unlock variable stored in the memory 216 or in the flash memory 214) indicating whether the electronic device 202 is permitted to seek unlocking over a network. For instance, the BIOS 208 may determine that a network unlock variable indicates that the electronic device 202 is permitted to seek unlocking over a network.

In some examples, the BIOS 208 (e.g., processor 206) may check the components of the electronic device 202 to determine that a network adapter (e.g., communication hardware) is included in the electronic device 202 (e.g., that the communication device 210 is included) or coupled to the electronic device 202. In some examples, the BIOS 208 (e.g., processor 206) may communicate with the communication device 210 to determine that a network link is present (e.g., an Ethernet cable is connected to the communication device 210, a USB cable is plugged in to the communication device 210, a wireless adapter has detected an available wireless network, etc.).

In some examples, in a case that the condition is satisfied (e.g., one of the foregoing conditions is satisfied, a combination of the two, three, or four of the foregoing conditions is satisfied, the BIOS 208 produces a determination that the condition is satisfied, etc.), the BIOS 208 (e.g., processor 206) may establish a network connection. For instance, the BIOS 208 (e.g., processor 206) may load a network stack (e.g., instruction(s), data structure(s), etc.) in the memory 216. In some examples, the BIOS 208 may determine a first network address for the communication device 210. The BIOS 208 (e.g., processor 206) may obtain a network address via a protocol (e.g., dynamic host control protocol (DHCP) or another protocol). For instance, the BIOS 208 may control the communication device 210 to request a network address for the communication device 210 via the network link.

In some examples, the BIOS 208 may determine a second network address of a server. For instance, the BIOS 208 (e.g., processor 206) may utilize a protocol (e.g., simple service discovery protocol (SSDP) or another protocol) to determine a second network address of a server. For instance, the BIOS 208 may control the communication device 210 to request a network address for a server on the network that provides an unlocking service.

The communication device 210 may output the second code. For instance, the communication device 210 may output, in response to the determination that the condition is satisfied, a second code that is encrypted based on the first code.

In some examples, the communication device 210 may send the second code to a server. For instance, the communication device 210 may output the second code to the server based on the second network address. In some examples, the server is included in an intranet (e.g., isolated intranet, internal manufacturer factory intranet, customer intranet, entity intranet, etc.). In some examples, the second code may be included in a message (e.g., JavaScript object notation (JSON) payload). For instance, the communication device 210 may send a hypertext transfer protocol (HTTP) get request to the server. In some examples, the second code (e.g., JSON payload) may include similar information as information included in a QR code (e.g., BIOS challenge QR code).

In some examples, the communication device 210 (e.g., communication device 210 under control of the BIOS 208, processor 206, or a combination thereof) may output the second code. For example, the processor 206 (e.g., BIOS 208) may generate a QR code based on the second code. The communication device 210 may output the second code by sending the QR code to a display panel as described in FIG. 1.

The communication device 210 may receive an authentication message in response to the second code. The processor 206 (e.g., BIOS 208) may enter an unlocked state based on the authentication message. In some examples, the authentication message includes a certificate as described in FIG. 1.

In some examples, the authentication message may be received from an internal manufacturing factory server. For instance, an internal manufacturing factory server may include an unlock listener mapped to an address that receives the second code (e.g., HTTP GET request). In some examples, the unlock listener may utilize an identifier (e.g., UUID taken from the HTTP GET JSON message) and may call an application to request an unlock corresponding to the identifier. In some examples, the application may generate a certificate as described in FIG. 1.

The unlock listener may respond to the second code (e.g., HTTP GET request) with the authentication message. For instance, the authentication message payload may indicate an action to take after successfully validating the authentication message, a type of response, and other information (e.g., base 64 encoded binary, USB encoded information, etc.).

In some examples, the communication device 210 (e.g., BIOS 208) may receive the authentication message from the server. When the authentication message is received, for instance, the BIOS 208 (e.g., processor 206) may decode the information (e.g., binary) and process the information as a command. If the authentication message is successfully validated, the BIOS 208 may take the action indicated (e.g., reboot or shutdown as indicated by an action field in the HTTP GET response). In some examples, the electronic device 202 may add an event to a log for the action (e.g., an event may be added to an embedded controller event log for the action).

In some examples, the electronic device 202 may boot in a case that the authentication message was successfully validated. For instance, a pre-boot environment of the electronic device 202 may boot and perform a factory operation(s) (e.g., reset security defaults, clear branding information, etc.). In some examples, the electronic device 202 may perform a factory operation(s) in conjunction with the internal manufacturing factory server.

In some examples, the authentication message includes an unlock code decrypted from the second code. The processor 206 (e.g., BIOS 208) may enter the unlocked state in a case that the unlock code matches the first code. In some examples, the unlock code may be produced by decrypting the second code by another device (e.g., mobile device, server, etc.). For instance, the unlock code may be produced by a mobile device that is to capture an image of the QR code as described in FIG. 1. In some examples, a user may input the unlock code indicated by the mobile device.

In some examples, the communication device 210 may output the second code to a server (e.g., customer server, entity server, etc.) on an intranet, and may receive the unlock code from the server. For instance, the electronic device 202 may be shipped to an entity that includes an intranet (e.g., secure intake environment). The server may be utilized to determine an unlock code based on the second code.

In some examples, the server may include an unlock listener (e.g., a service provided by the server) mapped to the second address (e.g., SSDP provided location). The unlock listener may receive the second code (e.g., HTTP GET request) and may call an application (e.g., manager application for a cryptographic key(s)). For instance, the unlock listener may call the application with the second code (e.g., JSON payload) provided by the BIOS 208. The application may decrypt the second code to produce the unlock code (e.g., PIN). In some examples, the application permissions may be utilized to allow or deny access. For instance, the unlock listener may get an access token from a profile application (e.g., Active Directory) to access the application (e.g., the manager application for the cryptographic key(s)). The application may utilize a private key corresponding to the public key to decrypt the second code to produce the unlock code. The unlock code may be provided to the unlock listener.

The unlock listener may respond to the second code (e.g., HTTP GET request) with the unlock code (e.g., a payload that includes a PIN). In some examples, the unlock listener may also provide a parameter to instruct the electronic device 202 to take an action if the validation is successful.

The communication device 210 may receive the unlock code, which may be provided to the BIOS 208. When the BIOS 208 receives the unlock code (e.g., valid PIN), the BIOS 208 may enter the unlocked state. In some examples, the BIOS 208 may take an action indicated (e.g., reboot, shutdown, etc., as indicated by the HTTP GET response payload).

In some examples, the electronic device 202 may perform one, some, or all of the aspects, operations, elements, etc., described in one, some, or all of FIG. 1-5. In some examples, the electronic device 202 may include an element described in one, some, or all of FIG. 1-5.

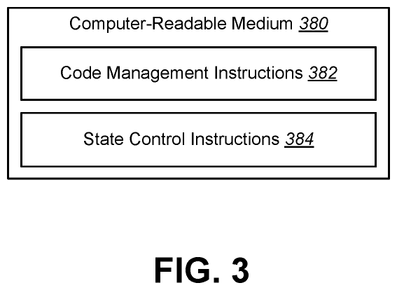

FIG. 3 is a block diagram illustrating an example of a computer-readable medium 380 for controlling locked states. The computer-readable medium 380 is a non-transitory, tangible computer-readable medium. In some examples, the computer-readable medium 380 may be, for example, RAM, DRAM, EEPROM, MRAM, PCRAM, a storage device, an optical disc, the like, or a combination thereof. In some examples, the computer-readable medium 380 may be volatile memory, non-volatile memory, or a combination thereof. In some examples, the computer-readable medium 380 described in FIG. 3 may be an example of memory including instructions to be executed by a processor to update instructions. For instance, the computer-readable medium 380 may be an example of the memory 216 described in FIG. 2, flash memory 214 described in FIG. 2, or a combination thereof.

The computer-readable medium 380 may include data (e.g., information, instructions). In the example of FIG. 3, the computer-readable medium 380 includes code management instructions 382 and state control instructions 384.

The code management instructions 382 may include instructions that, when executed, cause a processor of an electronic device to generate a first code. In some examples, generating the first code may be performed as described in FIG. 1, FIG. 2, or a combination thereof.

The code management instructions 382 may include instructions that, when executed, cause a processor of an electronic device to encrypt the first code based on a public key to produce a second code. In some examples, encrypting the first code may be performed as described in FIG. 1, FIG. 2, or a combination thereof.

The code management instructions 382 may include instructions that, when executed, cause a processor of an electronic device to control a communication device to send the second code to a server. In some examples, sending the second code may be performed as described in FIG. 1, FIG. 2, or a combination thereof.

The state control instructions 384 may include instructions that, when executed, cause the processor to enter a locked state, where a booting of an OS is blocked in the locked state, and where the locked state is unlockable with the first code. In some examples, entering the locked state may be performed as described in FIG. 1, FIG. 2, or a combination thereof.

The state control instructions 384 may include instructions that, when executed, cause the processor to enter an unlocked state based on an authentication message received in response to the second code when the electronic device is in the locked state. In some examples, entering the unlocked state may be performed as described in FIG. 1, FIG. 2, or a combination thereof. In some examples, the authentication message includes a certificate. In some examples, the state control instructions 384 may include instructions, that, when executed, cause the processor to enter the unlocked state in response to a determination that a received unlock code matches the first code.

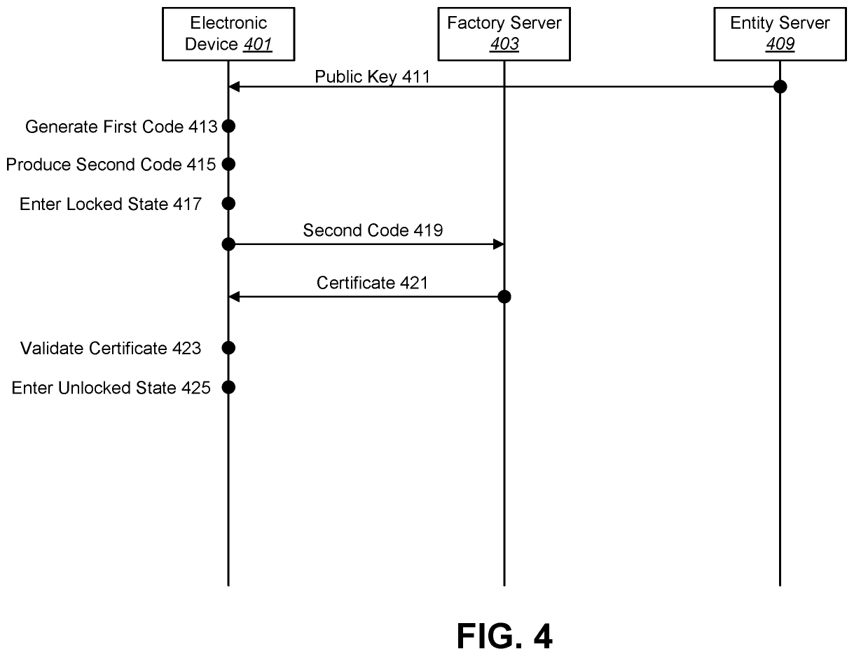

FIG. 4 is a thread diagram illustrating an example of locked state control in accordance with some examples of the techniques described herein. FIG. 4 illustrates examples of an electronic device 401, a factory server 403, and an entity server 409. In some examples, the electronic device 401, factory server 403, and entity server 409 may be examples of corresponding devices described in FIG. 1, FIG. 2, FIG. 3, or a combination thereof.

At step 411, the entity server 409 sends a public key to the electronic device 401. In some examples, sending the public key may be performed as described in FIG. 1, FIG. 2, FIG. 3, or a combination thereof.

At step 413, the electronic device 401 generates a first code. In some examples, generating the first code may be performed as described in FIG. 1, FIG. 2, FIG. 3, or a combination thereof.

At step 415, the electronic device 401 produces a second code. In some examples, producing the second code (e.g., encrypted code from the first code) may be performed as described in FIG. 1, FIG. 2, FIG. 3, or a combination thereof.

At step 417, the electronic device 401 enters a locked state. In some examples, entering the locked state may be performed as described in FIG. 1, FIG. 2, FIG. 3, or a combination thereof.

At step 419, the electronic device 401 sends the second code to the factory server 403. In some examples, sending the second code may be performed as described in FIG. 1, FIG. 2, FIG. 3, or a combination thereof.

At step 421, the factory server 403 sends a certificate. In some examples, sending the certificate may be performed as described in FIG. 1, FIG. 2, FIG. 3, or a combination thereof.

At step 423, the electronic device 401 validates the certificate. In some examples, validating the certificate may be performed as described in FIG. 1, FIG. 2, FIG. 3, or a combination thereof.

At step 425, the electronic device 401 enters an unlocked state. In some examples, entering the unlocked state may be performed as described in FIG. 1, FIG. 2, FIG. 3, or a combination thereof. For instance, the electronic device 401 may enter the unlocked state and permit booting in response to a successful validation of the certificate.

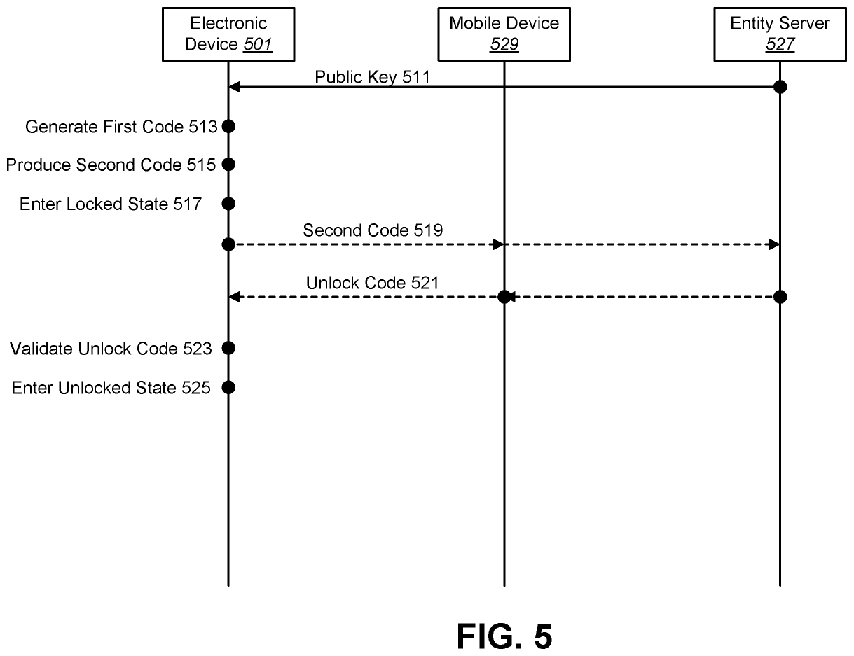

FIG. 5 is a thread diagram illustrating an example of locked state control in accordance with some examples of the techniques described herein. FIG. 5 illustrates examples of an electronic device 501, a mobile device 529, and an entity server 527. A mobile device (e.g., the mobile device 529) is an electronic device that is capable of functioning while mobile (e.g., while battery powered, while disconnected from mains electricity, etc.). Some examples of mobile devices may include smartphones, tablet devices, laptop computers, digital cameras, scanners, etc.). In some examples, the electronic device 501 may be an example of the electronic device described in FIG. 1, the electronic device 202 described in FIG. 2, the electronic device described in FIG. 3, or a combination thereof. In some examples, the mobile device 529 may be an example of the mobile device described in FIG. 1, the other device (e.g., mobile device) described in FIG. 2, or a combination thereof. In some examples, the entity server 527 may be an example of the customer server, ordering entity server, or the server on the intranet of a customer or ordering entity described in FIG. 1, the server (e.g., customer server, entity server, etc.) described in FIG. 2, the entity server 409 described in FIG. 4, or a combination thereof.

At step 511, the entity server 527 sends a public key to the electronic device 501. In some examples, sending the public key may be performed as described in FIG. 1, FIG. 2, FIG. 3, or a combination thereof.

At step 513, the electronic device 501 generates a first code. In some examples, generating the first code may be performed as described in FIG. 1, FIG. 2, FIG. 3, or a combination thereof.

At step 515, the electronic device 501 produces a second code. In some examples, producing the second code (e.g., encrypted code from the first code) may be performed as described in FIG. 1, FIG. 2, FIG. 3, or a combination thereof.

At step 517, the electronic device 501 enters a locked state. In some examples, entering the locked state may be performed as described in FIG. 1, FIG. 2, FIG. 3, or a combination thereof.

At step 519, the electronic device 501 sends the second code to the mobile device 529, to the entity server 527, or to a combination thereof. In some examples, sending the second code may be performed as described in FIG. 1, FIG. 2, FIG. 3, or a combination thereof. For instance, the electronic device 401 may output the second code encoded in a QR code, which may be read by the mobile device 529 (e.g., captured by an image sensor of the mobile device and decoded to indicate the second code). For instance, the mobile device 529 (e.g., smartphone, etc.) may include an image sensor that may be utilized to capture an image of the QR code. The mobile device 529 may include a processor to decode the QR code to produce the second code, and to decode the second code to produce an unlock code. In some examples, the mobile device may output the unlock code to a user (output via display, output via audio, or a combination thereof, etc.), may send the unlock code to the electronic device 501 (e.g., send the unlock code via a wired or wireless link, etc.), or a combination thereof. In some examples, the electronic device 401 may send the second code to the entity server 527 over an entity network (e.g., intranet). The entity server 527 may include a processor to decode the second code to produce an unlock code.

At step 521, the electronic device 501 receive an unlock code. In some examples, receiving the unlock code may be performed as described in FIG. 1, FIG. 2, FIG. 3, or a combination thereof. For instance, a user may input the unlock code indicated by the mobile device 529, the electronic device 501 may receive the unlock code from the mobile device 529 over a link, or the entity server 527 may send the unlock code via a network.

At step 523, the electronic device 501 validates the unlock code. In some examples, validating the unlock code may be performed as described in FIG. 1, FIG. 2, FIG. 3, or a combination thereof.

At step 525, the electronic device 501 enters an unlocked state. In some examples, entering the unlocked state may be performed as described in FIG. 1, FIG. 2, FIG. 3, or a combination thereof. For instance, the electronic device 501 may enter the unlocked state and permit booting in response to a successful validation of the unlock code.

Some examples of the techniques described herein provide approaches to lock an electronic device. For instance, locking an electronic device may provide a security feature to customers that purchase electronic devices. A customer may provide a public key, which may be provisioned to an electronic device manufactured in a factory. In some examples, a customer may be enabled to choose to have an electronic device shipped in a locked state, where the electronic device cannot be booted from the time it leaves the factory until it is unlocked by the customer using a private key that is confidential to the customer.

As used herein, items described with the term “or a combination thereof” may mean an item or items. For example, the phrase “A, B, C, or a combination thereof” may mean any of: A (without B and C), B (without A and C), C (without A and B), A and B (but not C), B and C (but not A), A and C (but not B), or all of A, B, and C.

While various examples are described herein, the disclosure is not limited to the examples. Variations of the examples described herein may be within the scope of the disclosure. For example, operation(s), function(s), aspect(s), or element(s) of the examples described herein may be omitted or combined.

What is claimed is:

1. An electronic device, comprising:
an operating system;
a processor to:
generate a first code;
encrypt the first code based on a public key to produce a second code; and
enter a locked state, wherein a booting of the operating system is blocked in the locked state, and wherein the locked state is unlockable with the first code; and
a communication device to:
output the second code; and
receive an authentication message in response to the second code, wherein the processor is to enter an unlocked state based on the authentication message.

2. The electronic device of claim 1, wherein the authentication message comprises a certificate.

3. The electronic device of claim 2, wherein the authentication message is received from an internal manufacturing factory server.

4. The electronic device of claim 1, wherein the authentication message comprises an unlock code decrypted from the second code.

5. The electronic device of claim 4, wherein the processor is to generate a quick response (QR) code based on the second code, and wherein the communication device is to output the second code by sending the QR code to a display panel.

6. The electronic device of claim 5, wherein the unlock code is produced by decrypting the second code by a mobile device that is to capture an image of the QR code.

7. The electronic device of claim 4, wherein the processor is to enter the unlocked state in a case that the unlock code matches the first code.

8. The electronic device of claim 4, wherein the communication device is to output the second code to a server on an intranet, and is to receive the unlock code from the server.

9. The electronic device of claim 1, further comprising a basic input/output system (BIOS) to determine whether a condition is satisfied, and wherein the communication device is to send the second code in a case that the condition is satisfied.

10. The electronic device of claim 9, wherein the condition is satisfied in a case that the electronic device is in the locked state, a network adapter is present, and a network link is present.

11. An electronic device, comprising:
an operating system;
a basic input/output system (BIOS) to:
enter a locked state, wherein a booting of the operating system is blocked in the locked state; and
produce, in response to an activation, a determination that a condition is satisfied;
a communication device to:
output, in response to the determination, a second code that is encrypted based on a first code; and
receive an authentication message in response to the second code, wherein the BIOS is to enter an unlocked state based on the authentication message.

12. The electronic device of claim 11, wherein the condition is satisfied in a case that the electronic device is in the locked state, a network adapter is present, and a network link is present.

13. The electronic device of claim 11, wherein in response to the determination, the BIOS is to:
load a network stack; and
determine a first network address for the communication device.

14. The electronic device of claim 13, wherein in response to the determination, the BIOS is to determine a second network address of a server, wherein the communication device is to output the second code to the server based on the second network address.

15. The electronic device of claim 14, wherein the server is included in an intranet, wherein the server is to send the authentication message in response to the second code.

16. The electronic device of claim 11, wherein the BIOS is to enter the unlocked state in a case that the authentication message includes an unlock code that matches the first code.

17. A non-transitory tangible computer-readable medium comprising instructions when executed cause a processor of an electronic device to:
generate a first code;
encrypt the first code based on a public key to produce a second code;
enter a locked state, wherein a booting of an operating system is blocked in the locked state, and wherein the locked state is unlockable with the first code; and
enter an unlocked state based on an authentication message received in response to the second code when the electronic device is in the locked state.

18. The non-transitory tangible computer-readable medium of claim 17, wherein the instructions when executed cause the processor to control a communication device to send the second code to a server.

19. The non-transitory tangible computer-readable medium of claim 18, wherein the authentication message comprises a certificate.

20. The non-transitory tangible computer-readable medium of claim 17, wherein the instructions when executed cause the processor to enter the unlocked state in response to a determination that a received unlock code matches the first code.
